(19) United States
(12) Patent Application Publication
(10) Pub. No.: US 2019/0297180 A1
(43) Pub. Date: Sep. 26, 2019

(54) VOICE CHAT AMELIORATION SYSTEM AND METHOD

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: SHI JIA, Zhengzhou (CN); JUN-WEI ZHANG, Zhengzhou (CN)

(21) Appl. No.: 15/978,257

(22) Filed: May 14, 2018

(30) Foreign Application Priority Data
Mar. 23, 2018 (CN) 201810246451.1

(51) Int. Cl. H04M 1/64; H04L 12/26; G10L 15/22

(52) U.S. Cl. CPC H04M 1/642; G10L 15/22; H04L 43/0817

(57) ABSTRACT

An electronic device includes a communication unit configured to establish communication with a second electronic device. The electronic device is configured to detect in real time, after a voice chat has been started between the electronic device and the second electronic device, a status of the electronic device and the second electronic device, determine whether the status of at least one of the electronic device and the second electronic device is abnormal, record current voice input data when it is determined that the status of at least one of the electronic device and the second electronic device is abnormal, and send the recorded current voice input data to the second electronic device.

### CROSS-REFERENCE TO RELATED APPLICATIONS

This application claims priority to Chinese Patent Application No. 201810246451.1 filed on Mar. 23, 2018, the contents of which are incorporated by reference herein.

### FIELD

The subject matter herein generally relates to voice chat applications in electronic devices, and more particularly to a system and method for improving a voice chat session.

### BACKGROUND

Generally, if a signal of an electronic device is bad during a voice chat session, another user of the voice chat session may not hear a voice message clearly.

### BRIEF DESCRIPTION OF THE DRAWINGS

Implementations of the present disclosure will now be described, by way of example only, with reference to the attached figures.

FIG. 1 is a block diagram of a first electronic device in communication with a second electronic device.

FIG. 2 is a block diagram of the first electronic device of FIG. 1.

FIG. 3 is a block diagram of function modules of a voice chat amelioration system implemented in the first electronic device.

FIG. 4 is a flow chart of a method for improving a voice chat session.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

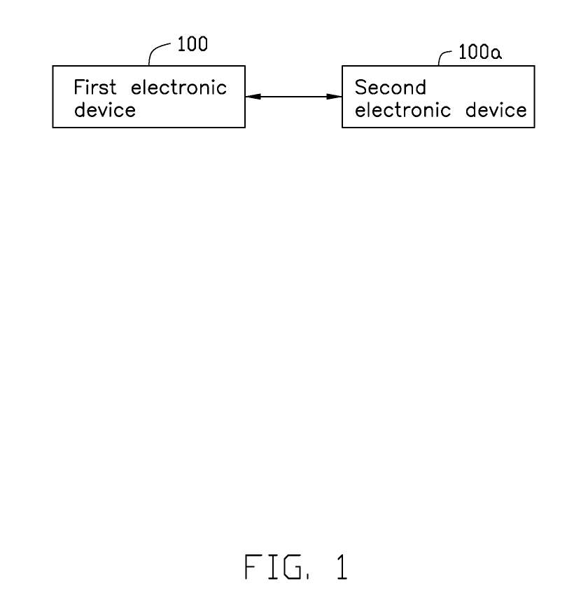

FIG. 1 illustrates an embodiment of a first electronic device 100 in communication with at least one second electronic device 100a. The first electronic device 100 and the second electronic device 100a each have installed therein a chat communication application. A user of the first electronic device 100 and a user of the second electronic device 100a can communicate through the chat communication application, such as by voice messaging. When voice communication between the first electronic device 100 and the second electronic device 100a encounters an abnormal status (such as an unstable connection or a broken connection), the first electronic device 100 records current voice input data and sends the recorded voice input data to the second electronic device 100a. The first electronic device 100 further receives recorded voice input data from the second electronic device 100a and outputs the received recorded voice input data for the user. In this way, when the voice communication encounters an abnormal status, the first electronic device 100 allows the user to listen to the voice input data. Furthermore, the first electronic device 100 further converts the voice input data into text data, which can be read by the user, thereby enhancing user experience.

In at least one embodiment, the first electronic device 100 may be, but is not limited to, a mobile phone, a tablet computer, a telephone watch, a desktop computer having a microphone and speaker, an all-in-one machine, or any other electronic device having online voice chat capabilities. In at least one embodiment, the chat communication application may be, but is not limited to, WECHAT, QQ, or other online messaging application.

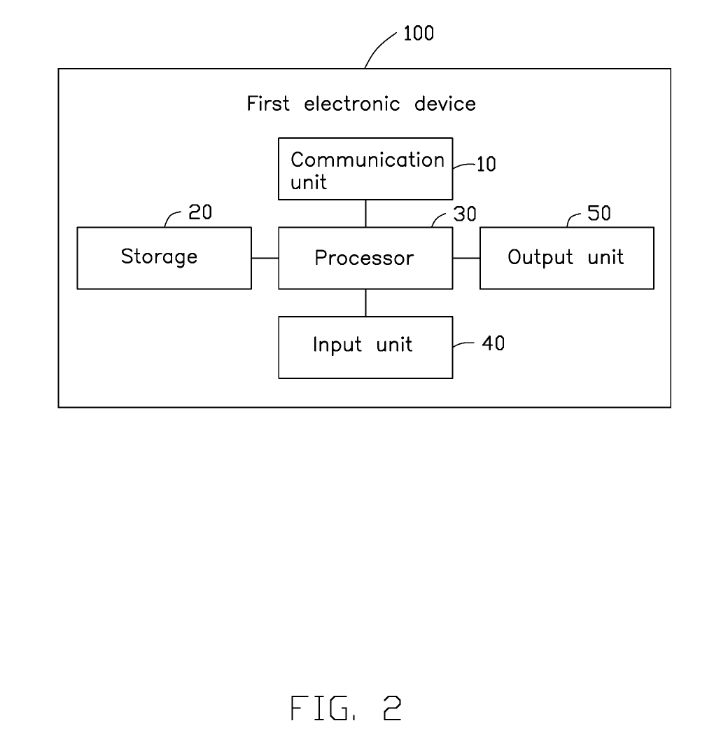

Referring to FIG. 2, the first electronic device 100 includes a communication unit 10, a storage 20, a processor 30, an input unit 40, and an output unit 50. It should be understood that FIG. 2 does not illustrate every component of the first electronic device 100, and the first electronic device 100 may include other components, such as a circuit board, a sound system, an input/output port, a battery, an operating system, and the like.

The communication unit 10 establishes communication between the first electronic device 100 and the second electronic device 100a.

In at least one embodiment, the communication unit 10 may establish communication with the second electronic device 100a through a wired or wireless connection. The wired connection may be, though not limited to, Internet, local area network, or the like. The wireless connection may be, but is not limited to, Wireless Fidelity (WIFI), radio, a cellular network, a satellite network, a broadcast network, or the like. The wireless communication technology may be, but is not limited to, global system for mobile communications (GSM), general packet radio service (GPRS), code division multiple access (CDMA), W-CDMA, CDMA2000, IMT single carrier, enhanced data rates for GSM evolution (EDGE), long-term evolution (LTE), time-division LTE (TD-LTE), high performance radio local area network (HiperLAN), high performance radio wide area network (HiperWAN), local multipoint distribution service (LMDS), worldwide interoperability for microwave access (WiMAX), ZigBee, BLUETOOTH, flash orthogonal frequency-division multiplexing (Flash-OFDM), high capacity spatial division multiple access (HC-SDMA), universal mobile telecommunications system (UMTS), UMTS time-division duplexing (UMTS-TDD), evolved high speed packet access (HSPA+), time division synchronous code division multiple access (TD-SCDMA), evolution-data optimized (EV-DO), digital enhanced cordless telecommunications (DECT), or the like.

The storage 20 stores a plurality of data of the first electronic device 100, such as operating programs of the chat application. The storage 20 may include, but is not limited to, a read-only memory (ROM), a random access memory (RAM), a programmable read-only memory (PROM), an erasable programmable read-only memory (EPROM), a one-time programmable read-only memory (OTPROM), an electrically-erasable programmable read-only memory (EEPROM), a compact disc read-only memory (CD-ROM), or other optical disk, magnetic disk, magnetic tape storage, or other storage medium.

In at least one embodiment, the storage 20 stores at least one chat application installed in the first electronic device 100. The chat application provides an interface for voice chat between the first electronic device 100 and the second electronic device 100a.

The processor 30 may include, but is not limited to, one or more central processing units (CPU), microprocessing units, data processing chips, graphics processors, or the like.

The input unit 40 provides an interface for receiving user input and user commands. In at least one embodiment, the input unit 40 may include a microphone to allow a user to input voice input through the chat application. The input unit 40 may further include, but is not limited to, a mouse, keyboard, touch screen, a camera, a remote control, or other suitable connection for inputting text data, and user commands, such as turning on and off the chat application.

The output unit 50 outputs data, such as audio, text data, image data, and the like. In at least one embodiment, the output unit 50 includes an audio output unit, such as a speaker, and a display unit, such as a liquid crystal display, a touch screen, or the like. The audio output unit outputs audio signals. The display unit displays images, animations, text data, and the like. For example, when the first electronic device 100 establishes communication with the second electronic device 100a through the chat application, the output unit 50 outputs audio signals.

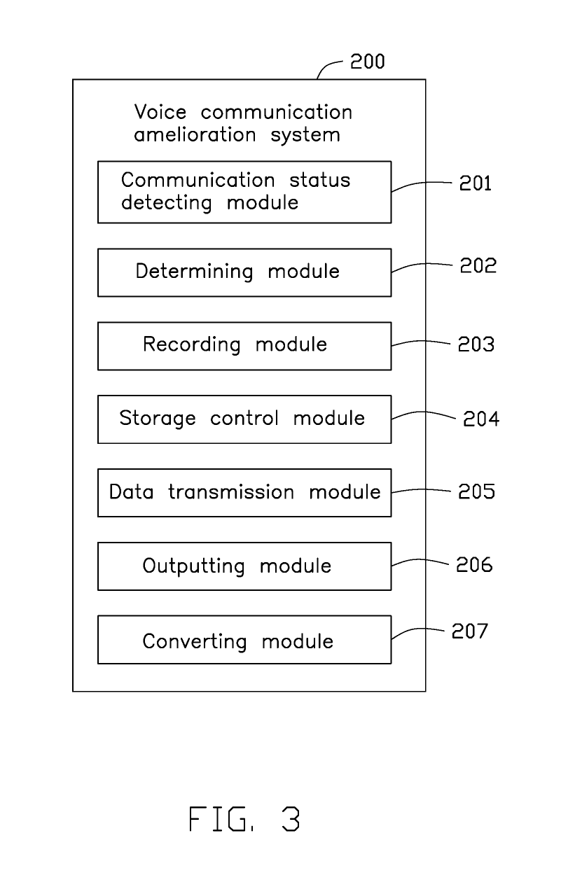

Referring to FIG. 3, the first electronic device 100 implements a voice communication amelioration system 200 (hereinafter “the system 200”). The system 200 includes one or more software programs in the form of computerized codes stored in the storage 20. The computerized codes include instructions executed by the processor 30 to provide functions for the system 200.

The system 200 includes a plurality of modules, such as a communication status detecting module 201, a determining module 202, a recording module 203, a storage control module 204, a data transmission module 205, and an outputting module 206.

The communication status detecting module 201 detects in real time, after a voice chat has been started between the first electronic device 100 and the second electronic device 100a, a status of the first electronic device 100 and the second electronic device 100a. In at least one embodiment, the status refers to a network signal strength. In another embodiment, the status may include, but is not limited to, a network signal strength, a data transmission speed, a signal to noise ratio, or whether a network connection is dropped. In at least one embodiment, the communication status detecting module 201 detects the status by detecting communication data. The second electronic device 100a also implements the system 200. Thus, the communication status detecting module 201 obtains the status of the second electronic device 100a.

The determining module 202 determines whether the status of the first electronic device 100 and the second electronic device 100a is abnormal. In at least one embodiment, the determining module 202 determines whether the status of the first electronic device 100 and the second electronic device 100a is abnormal by determining whether the status of at least one of the first electronic device 100 and the second electronic device 100a satisfies a predetermined condition. When the status of at least one of the first electronic device 100 and the second electronic device 100a satisfies the predetermined condition, then the determining module 202 determines that the status is abnormal. When the status of at least one of the first electronic device 100 and the second electronic device 100a does not satisfy the predetermined condition, then the determining module 202 determines that the status is not abnormal. The determining module 202 determines whether the status satisfies the predetermined condition by comparing the status to a preset range stored in the storage 20. When the status exceeds the preset status range, then the determining module 202 determines that the status is abnormal. When the status does not exceed the preset status range, then the determining module 202 determines that the status is not abnormal. For example, when the communication status detecting module 201 detects a wireless signal strength, then the determining module 202 determines whether the wireless signal strength is less than or equal to a preset value, such as −70 decibel-milliwatts (dBm). When the signal strength is less than or equal to the preset value, then the determining module 202 determines that the status is abnormal. When the status is not abnormal, then the voice chat continues.

The recording module 203 records current voice input data when it is determined that the status is abnormal.

In at least one embodiment, after the recording module 203 starts recording, the detecting module 201 continues detecting the status, until the determining module 202 determines whether the status has returned to normal. When the determining module 202 determines that the status has returned to normal, the recording module 203 stops recording. In at least one embodiment, the determining module 202 determines that the status has returned to normal when the status returns to the preset range.

The storage control module 204 stores the recorded voice input data to the storage 20.

The data transmission module 205 sends the voice input data to the second electronic device 100a after processing and converting the voice input data.

In detail, in at least one embodiment, after the determining module 202 determines that the status of the first electronic device 100 has returned to normal, the data transmission module 205 sends the recorded voice input data to the second electronic device 100a, and simultaneously receives recorded voice input data from the second electronic device 100a. In another embodiment, the data transmission module 205 may send every sentence spoken by a user to the second electronic device 100a immediately after the sentence is finished. For example, the sentences are determined by a pause in speaking lasting for a predetermined time duration, such as 2 seconds.

In detail, in at least one embodiment, when the determining module 202 determines that the status of the first electronic device 100 and the second electronic device 100a has returned to normal, the determining module 202 further determines whether the abnormal status lasted for less than a preset time duration, such as one second. When the abnormal status lasts for more than the preset time duration, then the storage control module 204 and the data transmission module 205 store and send the voice input data. When the abnormal status lasts for less than the preset time duration then the recording module 203 does not save the recorded voice input data.

The data transmission module 205 further obtains the recorded voice input data from the second electronic device 100a through the communication unit 10.

The outputting module 206 outputs the voice input data obtained by the data transmission unit 205 from the second electronic device 100a to the user.

In detail, in at least one embodiment, the system 200 further includes a converting module 207. The converting module 207 converts the recorded voice input data into text data. The data transmission module 205 sends the text data to the second electronic device 100a, and simultaneously receives the text data from the second electronic device 100a. It is to be understood that in other embodiments, the data transmission module 205 may send the text data and the voice input data together to the second electronic device 100a, and receive the corresponding voice input data and the text data from the second electronic device 100a.

The outputting module 206 displays the text data.

Furthermore, in at least one embodiment, the recording module 203 records a time of recording the voice input data. Correspondingly, the voice input data/text data received by the data transmission module 205 from the second electronic device 100a includes a time of recording the voice input data. The outputting module 206 outputs the voice input data and the voice input data/text data received from the second electronic device in sequence on a timeline.

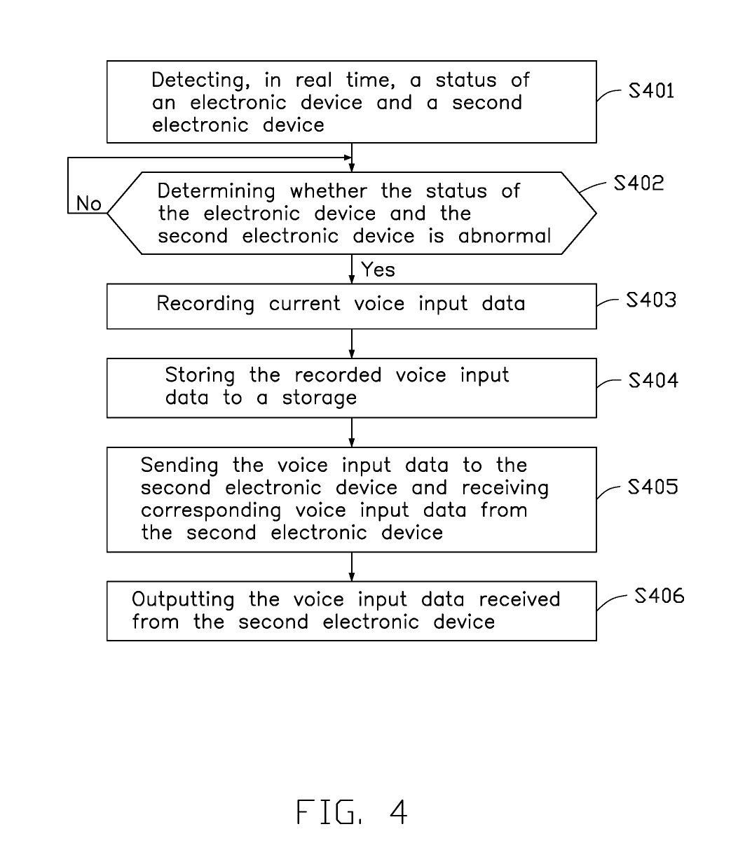

FIG. 4 illustrates a flowchart of an exemplary method for improving a network voice conversation. The example method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 401.

At bock 401, after the first electronic device 100 establishes communication with the second electronic device 100a, the communication status detecting module 201 detects, in real time, a status of the first electronic device 100 and the second electronic device 100a.

In at least one embodiment, the communication status detecting module 201 detects the status by detecting communication data of the communication unit 10.

At block 402, the determining module 202 determines whether the status of the first electronic device 100 or the second electronic device 100a is abnormal. When the status is abnormal, block 403 is implemented. When the status is not abnormal, block 402 is repeated.

In detail, in at least one embodiment, the determining module 202 determines whether the status is abnormal by comparing the status to a preset range stored in the storage 20. When the status exceeds the preset status range, then the determining module 202 determines that the status is abnormal. When the status does not exceed the preset status range, then the determining module 202 determines that the status is not abnormal.

At block 403, the recording module 203 records current voice input data.

In detail, in at least one embodiment, after the recording module 203 starts recording, the detecting module 201 continues detecting the status, and the determining module 202 determines whether the status has returned to normal. When the determining module 202 determines that the status has returned to normal, the recording module 203 stops recording.

At block 404, the storage control module 204 stores the recorded voice input data to the storage 20. In another embodiment, step 404 may be omitted.

In detail, in at least one embodiment, when the determining module 202 determines that the status of the first electronic device 100 or the second electronic device 100a has returned to normal, the determining module 202 further determines whether the abnormal status lasted for less than a preset time duration, such as one second. When the abnormal status lasted for more than the preset time duration, then the storage control module 204 stores the recorded voice input to the storage 20. When the abnormal status lasted for less than the preset time duration then the recording module 203 does not save the recorded voice input data.

At block 405, the data transmission module 205 sends the voice input data to the second electronic device 100a through the communication unit 10 after processing and converting the voice input data, and receives corresponding voice input data from the second electronic device 100a through the communication unit 10.

At block 406, the outputting module 206 outputs the voice input data obtained by the data transmission module 205.

In at least one embodiment, before block 404, the converting module converts the recorded voice input data into text data, and the storage control module 204 stores the text data to the storage 20. The data transmission module 205 sends the text data to the second electronic device 100a, and simultaneously receives the text data from the second electronic device 100a.

Furthermore, in at least one embodiment, the recording module 203 records a time of recording the voice input data. Correspondingly, the voice input data/text data received by the data transmission module 205 from the second electronic device 100a includes a time of recording the voice input data. The outputting module 206 outputs the voice input data and the voice input data/text data received from the second electronic device in sequence on a timeline.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for improving a voice chat session implemented in an electronic device configured to establish voice communication with a second electronic device over a network, comprising:
detecting in real time, after a voice chat has been started between the electronic device and the second electronic device, a status of the electronic device and the second electronic device;
determining whether the status of at least one of the electronic device and the second electronic device is abnormal;
recording, when it is determined that the status of at least one of the electronic device and the second electronic device is abnormal, current voice input data; and
sending the recorded current voice input data to the second electronic device.

2. The method of claim 1, wherein the step of determining whether the status of at least one of the electronic device and the second electronic device is abnormal comprises:
comparing the status to a preset range stored in a storage to determine whether the status exceeds the preset range;
determining, when the status exceeds the preset range, that the status is abnormal; and
determining, when the status does not exceed the preset range, that the status is not abnormal.

3. The method of claim 1, wherein after the voice input data is started to be recorded, the method further comprises:
continuing detecting whether the status of at least one of the electronic device and the second electronic device is abnormal, and determining whether the status has returned to normal; and
ceasing recording of the voice input data when the status has returned to normal.

4. The method of claim 3 further comprising:
determining, after determining that the status has returned to normal, whether a time duration of the abnormal status was less than or more than a preset time duration;
sending the recorded voice input data to the second electronic device when the time duration of the abnormal status is determined to be more than the preset time duration; and
deleting the recorded voice input data when the time duration of the abnormal status is determined to be less than the preset time duration.

5. The method of claim 1 further comprising:
obtaining an audio signal from the second electronic device; and
outputting the audio signal obtained from the second electronic device.

6. The method of claim 1 further comprising:
converting the recorded voice input data into text data;
sending the text data to the second electronic device and obtaining text data converted from voice input data from the second electronic device; and
outputting the text data from the electronic device and the second electronic device.

7. The method of claim 6, wherein when the current voice input data is being recorded, a time of recording the current voice input data is simultaneously recorded; a time of the text data received from the second electronic device is also received; the text data is output in a timeline according to the corresponding time.

8. An electronic device comprising:
a communication unit configured to establish communication with a second electronic device;
a processor; and
a storage configured to store a plurality of instructions, which when executed by the processor, cause the processor to:
detect in real time, after a voice chat has been started between the electronic device and the second electronic device, a status of the electronic device and the second electronic device;
determine whether the status of at least one of the electronic device and the second electronic device is abnormal;
record, when it is determined that the status of at least one of the electronic device and the second electronic device is abnormal, current voice input data; and
send the recorded current voice input data to the second electronic device.

9. The electronic device of claim 8, wherein the step of determining whether the status of at least one of the electronic device and the second electronic device is abnormal comprises:
comparing the status to a preset range stored in a storage to determine whether the status exceeds the preset range;
determining, when the status exceeds the preset range, that the status is abnormal; and
determining, when the status does not exceed the preset range, that the status is not abnormal.

10. The electronic device of claim 1, wherein after the voice input data is started to be recorded, the processor is further configured to:
continue detecting whether the status of at least one of the electronic device and the second electronic device is abnormal, and determine whether the status has returned to normal; and
cease recording of the voice input data when the status has returned to normal.

11. The electronic device of claim 10, wherein the processor is further configured to:
determine, after determining that the status has returned to normal, whether a time duration of the abnormal status was less than or more than a preset time duration;
send the recorded voice input data to the second electronic device when the time duration of the abnormal status is determined to be more than the preset time duration; and
not save the recorded voice input data when the time duration of the abnormal status is determined to be less than the preset time duration.

12. The electronic device of claim 8, wherein the processor is further configured to:
obtain an audio signal from the second electronic device; and
output the audio signal obtained from the second electronic device.

13. The electronic device of claim 8, wherein the processor is further configured to:
convert the recorded voice input data into text data;
send the text data to the second electronic device and obtain text data converted from voice input data from the second electronic device; and
output the text data of the electronic device and the second electronic device.

14. The electronic device of claim 13, wherein when the current voice input data is being recorded, a time of recording the current voice input data is simultaneously recorded; a time of the text data received from the second electronic device is also received; the text data of the electronic device and of the second electronic device is output in a timeline according to the corresponding time.

15. A non-transitory storage medium having stored thereon instructions that, when executed by at least one processor of a computing device, causes the least one processor to execute instructions of a method for automatically testing signal integrity of an electronic product, the method comprising:
detecting in real time, after a voice chat has been started between the electronic device and the second electronic device, a status of the electronic device and the second electronic device;
determining whether the status of at least one of the electronic device and the second electronic device is abnormal;
recording, when it is determined that the status of at least one of the electronic device and the second electronic device is abnormal, current voice input data; and
sending the recorded current voice input data to the second electronic device.

16. The non-transitory storage medium of claim 15, wherein the step of determining whether the status of at least one of the electronic device and the second electronic device is abnormal comprises:
comparing the status to a preset range stored in a storage to determine whether the status exceeds the preset range;
determining, when the status exceeds the preset range, that the status is abnormal; and
determining, when the status does not exceed the preset range, that the status is not abnormal.

17. The non-transitory storage medium of claim 15, wherein after the voice input data is started to be recorded, the method further comprises:
continuing to detect whether the status of at least one of the electronic device and the second electronic device is abnormal, and determining whether the status has returned to normal; and
ceasing recording of the voice input data when the status has returned to normal.

18. The non-transitory storage medium of claim 17 further comprising:
determining, after determining that the status has returned to normal, whether a time duration of the abnormal status was less than or more than a preset time duration;
sending the recorded voice input data to the second electronic device when the time duration of the abnormal status is determined to be more than the preset time duration; and
deleting the recorded voice input data when the time duration of the abnormal status is determined to be less than the preset time duration.

19. The non-transitory storage medium of claim 15 further comprising:
obtaining an audio signal from the second electronic device; and
outputting the audio signal obtained from the second electronic device.

20. The non-transitory storage medium of claim 15 further comprising:
converting the recorded voice input data into text data;
sending the text data to the second electronic device and obtaining text data converted from voice input data from the second electronic device; and
outputting the text data from the electronic device and the second electronic device.
